(19) United States
(12) Patent Application Publication
(10) Pub. No.: US 2011/0300260 A1
(43) Pub. Date: Dec. 8, 2011

(54) METHOD FOR PREPARATION OF FROZEN MICROWAVE INSTANT FOOD

(76) Inventor: Shuyu CAO, Tainan City (TW)

(21) Appl. No.: 12/880,202

(22) Filed: Sep. 13, 2010

(30) Foreign Application Priority Data
Jun. 4, 2010 (CN) 201010191892.X

(51) Int. Cl. A23L 1/318; A23L 3/36

(52) U.S. Cl. 426/58; 426/281

(57) ABSTRACT

The present invention provides a method for preparation of frozen microwave instant food, wherein the main process is that before being cooked the ingredients are shaped (to ordinary shape or crushing, fine crushing, mashing shape) and impregnated. The impregnating solution used is an aqueous solution containing 30˜150 g/L of trehalose and 1˜100 g/L of polysaccharides, glue, phosphatide, starch, polylactic acid, edible tackifier or edible adhesive Trehalose and polysaccharides, glue, phosphatide, starch, polylactic acid, edible tackifier or edible adhesive, or combination thereof are used to coat the ingredients, thus membranes are formed on the ingredients to improve moisture holding capacity, reduce volatilization, stabilize food structure, inhibit starch retrogradation, protein denaturation, oil decay, unsaturated fatty acid decomposition when the fish being heated, and vegetable and fruit browning, as well as protect the tissue, so that the moisture holding capacity and dry taste of the frozen food are improved.

### FIELD OF THE INVENTION

The present invention relates to a method for preparation of frozen microwave instant food, especially relates to a method for preparation of frozen microwave instant food with improved moisture holding capacity and frost resistance of the ingredients, inhibited retrogradation, dehydration, denaturation and rancidity of the ingredients during the freezing and heating process, maintained original taste and nutrition of the ingredients, increased the additive nutritional value, as well as improved dry taste loss of frozen microwave instant food, in particular for the old and patient having metabolism syndrome.

### BACKGROUND ART

Generally, the whole preparation process for frozen food must be carried out under hypothermia and sterile condition. After entering plant the ingredients must be quickly washed to remove sediment and contaminants, sterilized, shaped (to ordinary shape, crushing or mashing shape), then heated and prepared. The prepared food must be packed after quickly cooling and freezing (it is cooled from 100° C. to −18° C.˜−60° C. within 2 hours). The above quick freezing technology is superior to common freezing technology due to quick freezing which make moisture in food form fine and uniform ice crystal, thereby not destroying the texture of food. The quick freezing technology can not only avoid bigger ice crystal forming inside the food, but also inhibit or reduce ferment effect, chemical change and microorganism reproduction caused by slow cooling. Since the whole process is carried out under sterile and low-temperature condition, it is not necessary to add preservatives to frozen food prepared by quick freezing.

In common method for preparation with lower freezing rate, larger ice crystal that is liable to burst the structure and tissue of the food will be generated inside the food, causing the texture of the food and the flavor to deteriorate after thawing and heating.

By quick freezing, though original taste of the ingredients is maintained, the tissue of the ingredients are affected. And the ingredients can release moisture when being thawed and heated, causing the quality to deteriorate.

In prior art of freezing, most kinds of vegetable and fruit except root vegetables such as Brassica oleracea L. var. italica Plench, carrot, corn and potato are not suitable to prepare frozen prepared food.

In order to improve the tender taste of meat, in prior art, the meat is impregnated into the acidic solution to change its structure, but because of this its nutrition and flavor is affected.

Since starch retrogradation temperature is about 4° C., the cooked rice preserved in refrigerator turns white and dry more quickly than in normal temperature, and may turn to rigid grain if it continues to be frozen preserved, which will be too bitter for deglutition. Therefore, only fried rice coated with excipients such as oil is for sale on the market.

### SUMMERY OF THE INVENTION

The main purpose of the present invention is to provide a method for preparation of frozen microwave instant food, with improved moisture holding capacity and frost resistance of the ingredients, inhibited retrogradation, dehydration, denaturation and rancidity of the ingredients, maintained original taste and nutrition of the ingredients, increased additive nutritional value, as well as improved dry taste loss of frozen microwave instant food.

In order to achieve the above purpose, the present invention provides a method for preparation of frozen microwave instant food, including the following steps of:
a. Cleaning and disinfecting the ingredients;
b. Shaping the ingredients and then impregnating into the impregnating solution;
c. Cooking and heating the ingredients;
d. Quickly freezing and packing the ingredients;

wherein said impregnating solution used to impregnate the ingredients are an aqueous solution containing 30˜150 g/L of trehalose and 1˜100 g/L of polysaccharides, glue, phosphatide, starch, polylactic acid, edible tackifier or edible adhesive.

Preferably, the ingredients are generally shaped and cut into ordinary size, or crushing size of 2˜1 cm, fine crushing size of 1˜0.3 cm, mashing size of smaller than 0.3 cm.

Preferably, the ingredients are placed into said impregnating solution for 10 min to 3 hours under room temperature or 25˜5° C.

Preferably, the ingredients are meat, and the meat quality is improved and softened by beetling the meat, or impregnating the meat into the mixed solution containing said impregnating solution as substrate, with one or more juice of fruit, yogurt, beneficial bacteria or enzyme added before said ingredients being put into the impregnating solution, so that the meat quality is soft and tender, as well as propitious to mastication.

Preferably, the method used in said quick freezing is individually quick freezing, quick freezing, semi-air blast freezing, air blast freezing, liquefied nitrogen freezing, secondary cooling medium freezing, or contact freezing.

More preferably, quick freezing process of said ingredients are cooled from 100° C. to 18° C. , and then from 18° C. to −40° C.˜−60° C., shortening the crystallization time of ice.

The following technical effect can be achieved in the present invention,

Before the ingredients being heat treated and cooked, an aqueous solution containing 30˜150 g/L of trehalose and 1˜100 g/L of polysaccharides, glue, phosphatide, starch, polylactic acid, edible tackifier or edible adhesive is prepared.

Then the ingredients are impregnated into the solution under room temperature or a low temperature of 25° C.-5° C. for 10 min to 3 hours (impregnating time depends on size of the ingredients), and the ingredients are then heat treated and cooked, thereby improving the moisture holding capacity and frost resistance of the ingredients, inhibiting the retrogradation, dehydration, denaturation and rancidity of the ingredients, maintaining the original taste and nutrition of the ingredients, increasing the additive nutritional value, and improving the dry taste loss of frozen microwave instant food.

BRIEF DESCRIPTIONS OF THE DRAWINGS

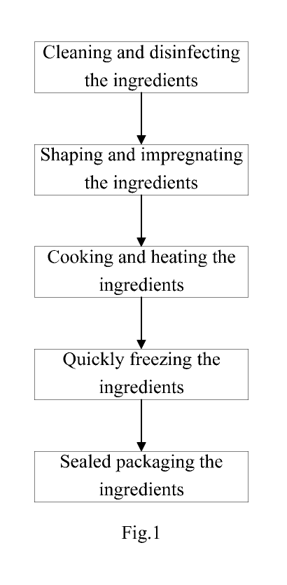

FIG. 1 shows flowchart of the present invention;

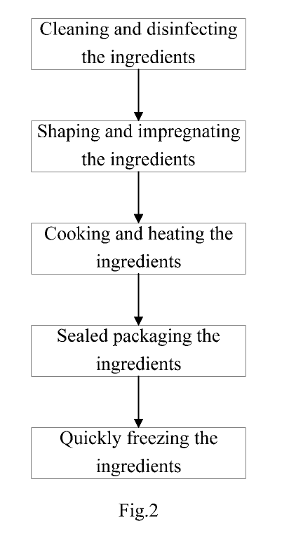

FIG. 2 shows another flowchart of the present invention;

### DETAILED DESCRIPTION OF THE EMBODIMENT

The scheme of the present invention is further described through the figures and specific embodiments so that the present invention is better understand and can be carried out by those skilled in the art. However, the present invention is by no means limited to the listed embodiments herein.

As shown in FIGS. 1 and 2, the method for preparation of frozen microwave instant food in the present invention, mainly including the following steps of:

a. Cleaning and disinfecting the ingredients (such as raw meat materials, vegetables and fruits, and cooked rice). The meat quality is improved and softened by beetling, or impregnating into the mixed solution containing the impregnating solution as substrate, with adding juice of fruit, yogurt, beneficial bacteria or enzyme, or combination thereof, in order to make the meat soft and tender;

b. Shaping and impregnating the ingredients. Referring to FIGS. 1 and 2, the ingredients such as fruits and vegetables are cleaned and shaped into ordinary shape, or crushing size of 2˜1 cm, fine crushing size of 1˜0.3 cm, mashing size of smaller than 0.3 cm. An aqueous solution containing 30˜150 g/L of trehalose and 1˜100 g/L of polysaccharides, glue, phosphatide, starch, polylactic acid, edible tackifier or edible adhesive is prepared. And the water consumption is dependent on the amount of the ingredients, for example, 30-150 g of trehalose is added to 1 kg of water, and then appropriate amount of tackifier powder is added. Shaped or unshaped ingredients are placed into the solution, and impregnated under room temperature or low temperature (25° C.-5° C.) for about 10 min to 3 hours. After cleaning, the raw meat materials are impregnated or salted under low temperature for about 10 min to 3 hours after adding salted meat seasoning and getting juice by twisting. And the impregnating or salting solution contains 30˜150 g/L of trehalose and 1˜100 g/L of polysaccharides, glue, phosphatide, starch, polylactic acid, commercially edible tackifier or edible adhesive as substrate solution, with fruit, yogurt, beneficial bacteria or enzyme added. After cleaning, the rice ingredients are made into cooked rice or porridge, and then impregnated into the aqueous solution containing 30˜150 g/L of trehalose and 1˜100 g/L of polysaccharides, glue, phosphatide, starch, polylactic acid, commercially tackifier or adhesive, depending on the quantity of cooked rice or porridge.

c. Cooking and heating the ingredients;

The ingredients are quick frozen and sealing packed. After cooking, All kinds of ingredients are sealing packed respectively, and then quick frozen (According to

FIG. 2, the ingredients are quick frozen after sealing packing.). All kinds of quick freezing technology or alternative scheme of quick freezing system can be used to shorten the crystallization time of ice.

The ingredients mentioned in the embodiments of the present invention are generally classified into common set meal (the ingredients are shaped to common size, i.e. the size of common meal), crushing shape (size of the ingredients are about 2˜1 cm), fine crushing shape (size of the ingredients are 1˜0.3 cm), mashed shape (size of the ingredients are smaller than 0.3 cm). Difference of the above ingredients are size and raw material. It is convenient for the group of person paying attention to health, the old with digestive tract degradation, and the person with teeth over-wore to eat.

In conclusion, before being cooked, the ingredients of the present invention are impregnated in aqueous solution containing trehalose and polysaccharides, glue, phosphatide, starch, polylactic acid, edible tackifier or edible adhesive. The ingredients are coated with trehalose and polysaccharides, glue, phosphatide, starch, polylactic acid, edible tackifier or edible adhesive, or combination thereof, in order to improve moisture holding capacity of the ingredients, to reduce evaporation, to stabilize the structure of the ingredients, to inhibit starch retrogradation, protein denaturation, oil decay, decomposition of unsaturated fatty acid when heating fish and browning in fruit and vegetable, as well as to protect tissue of the material. Moreover, trehalose is a biose comprising of two monosaccharide glucose, wherein the sweetness accounts for 45% of the granulated sugar. The trehalose possess moisture holding capacity, and it can inhibit starch retrogradation, protect protein from denaturation when over heated, mitigate oil decay, inhibit decomposition of the unsaturated fatty acid when the fish being heated and browning of fruit and vegetable, as well as change protective tissue (Small crystal generated from freezing of trehalose aqueous solution will not burst the cell wall and damage the tissue, and it can be complementary to all kinds of quick freezing technologies). Meanwhile, trehalose also possess the effect of inhibiting human adipose from increasing, promoting activity of beneficial bacteria, resisting the rising of blood glucose, and repairing human tissue. Polysaccharides (or glue, phosphatide, starch, polylactic acid, edible tackifier, edible adhesive) is glutin containing cellulose (Animal glue contains protein), calcium, iron and vitamin, which can repeatedly melt-refreeze, hold moisture, improve taste of the tissue, increase viscosity of the ingredients, reduce the cough chance of the old caused by functional degradation of digestive tract, and increase the chance of ingesting collagen, calcium, vitamin or dietary fiber, and also possess the effect of inhibiting arterial stiffness, decreasing blood pressure and blood lipid and reducing weight. Wherein, dietary fiber interacts with trehalose in intestine, i.e. trehalose stimulates beneficial intestinal bacteria to be active, while dietary fiber provides nutrition to the beneficial intestinal bacteria, so the additional nutrition value is high. Therefore, moisture holding capacity and frost resistance of the frozen prepared ingredients are improved, and retrogradation, dehydration, denaturation and rancidity of the ingredients during freezing and heating are inhibited.

The above examples are preferable examples to understand the spirit of the present invention, but the scope of the invention should not be limited to them. Any modifications or alternations may be made to the invention without deviating from the invention concept. The scope of protection of the present invention shall be determined by the terms of the claims.

1. A method for preparation of frozen microwave instant food, including the following steps of:
a. Cleaning and disinfecting the ingredients;
b. Shaping the ingredients and then impregnating into the impregnating solution;
c. Cooking and heating the ingredients;
d. Quickly freezing and packing the ingredients;
wherein said impregnating solution used to impregnate said ingredients are an aqueous solution containing 30˜150 g/L of trehalose and 1˜100 g/L of polysaccharides, glue, phosphatide, starch, polylactic acid, edible tackifier or edible adhesive .

2. The method for preparation of frozen microwave instant food according to claim 1, which is characterized in that said ingredients are shaped and cut into ordinary size, or crushing size of 2˜1 cm, fine crushing size of 1˜0.3 cm, mashing size of smaller than 0.3 cm.

3. The method for preparation of frozen microwave instant food according to claim 1, which is characterized in that said ingredients are placed into said impregnating solution for 10 min to 3 hours under room temperature or 25˜5° C.

4. The method for preparation of frozen microwave instant food according to claim 1, which is characterized in that said ingredient are meat, and the meat quality is improved and softened by beetling the meat, or impregnating the meat into the mixed solution containing said impregnating solution as substrate, with juice of fruit, yogurt, beneficial bacteria or enzyme, or combination thereof added before said ingredients being put into said impregnating solution, so that the meat quality is soft and tender, as well as propitious to mastication.

5. The method for preparation of frozen microwave instant food according to claim 1, which is characterized in that the method used in said quick freezing is individually quick freezing, quick freezing, semi-air blast freezing, air blast freezing, liquefied nitrogen freezing, secondary cooling medium freezing, or contact freezing.

6. The method for preparation of frozen microwave instant food according to claim 1, which is characterized in that quick freezing process of said ingredients are cooling from 100° C. to 18° C., and then from 18° C. to −40° C.˜−60° C., shortening the crystallization time of ice.
